(19) United States
(12) Patent Application Publication
(10) Pub. No.: US 2012/0252707 A1
(43) Pub. Date: Oct. 4, 2012

(54) METHODS AND COMPOSITIONS TO DELAY VISCOSIFICATION OF TREATMENT FLUIDS

(76) Inventors: Leiming Li, Sugar Land, TX (US); Lijun Lin, Sugar Land, TX (US)

(21) Appl. No.: 13/411,840

(22) Filed: Mar. 5, 2012

Related U.S. Application Data
(60) Provisional application No. 61/469,419, filed on Mar. 30, 2011.

(51) Int. Cl. C09K 8/80; C09K 8/62

(52) U.S. Cl. 507/213; 507/225; 507/217; 507/215; 507/216; 507/211

(57) ABSTRACT

The current application discloses a method of treating a portion of a subterranean formation comprises providing a treatment fluid comprising a carrier fluid, a non-hydrolyzed polyacrylamide or a nonhydrolyzed non ionic copolymer of acrylamide, and a delaying agent; and treating the subterranean formation.

### RELATED APPLICATION DATA

This application claims the priority of U.S. provisional application Ser. No. 61/469,419, the entire contents of which are incorporated by reference to the current application.

### BACKGROUND

The statements in this section merely provide background information related to the present disclosure and may not constitute prior art.

Hydraulic fracturing of oil or gas wells is a technique routinely used to improve or stimulate the recovery of hydrocarbons. In such wells, hydraulic fracturing is usually accomplished by introducing a proppant-laden treatment fluid into a producing interval at high pressures and at high rates sufficient to crack the rock open. This fluid induces a fracture in the reservoir as it leaks off in the surrounding formation and transports proppant into the fracture. After the treatment, proppant remains in the fracture in the form of a permeable and porous proppant pack that serves to maintain the fracture open as hydrocarbons are produced. In this way, the proppant pack forms a highly conductive pathway for hydrocarbons and/or other formation fluids to flow into the wellbore.

Despite numerous techniques developed for hydraulic fracturing, there remains room for improvement.

### SUMMARY

In some embodiments, there is provided a method of treating a portion of a subterranean formation. The method comprises providing a treatment fluid comprising a carrier fluid, a non-hydrolyzed polyacrylamide or a non-hydrolyzed non ionic copolymer of acrylamide, and a delaying agent, and treating the subterranean formation.

In some embodiments, there is disclosed a method of fracturing a portion of a subterranean formation penetrated by a wellbore. The method comprises providing a fracturing fluid comprising a carrier fluid and a non-hydrolyzed polyacrylamide or a non-hydrolyzed non ionic copolymer of acrylamide; fracturing the portion of the subterranean formation with said fracturing fluid; and providing to the fracturing fluid a delaying agent to increase the viscosity of the fracturing fluid.

In some embodiments, there is provided a method of fracturing a portion of a subterranean formation penetrated by a wellbore. The method comprises providing a fracturing fluid comprising a carrier fluid, a viscosifying agent and a non-hydrolyzed polyacrylamide or a non-hydrolyzed non ionic copolymer of acrylamide; fracturing the portion of the subterranean formation with said fracturing fluid; and providing to said fracturing fluid a delaying agent to increase the viscosity of the fracturing fluid.

The treatment fluid may further comprise a viscosifying agent. The viscosifying agent may be selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethycellulose (CMC), xanthan, diutan, scleroglucan and mixtures thereof. The viscosifying agent may also be a viscoelastic surfactant.

In some embodiments, the delaying agent is water. In some embodiments, the delaying agent is basic agent. Specifically, the delaying agent can be an alkali metal basic compound, such as ammonium hydroxides, sodium hydroxides, potassium hydroxides, carbonates, phosphates, alcoholates, silicates and mixtures thereof.

The treatment or fracturing fluid may further comprise proppant.

### BRIEF DESCRIPTION OF THE DRAWINGS

These and other features and advantages will be better understood by reference to the following detailed description when considered in conjunction with the accompanying drawings.

FIG. 1 shows the viscosity profile at 100 deg C. of the baseline fluid, and the baseline fluid containing 0.34 wt % NaOH, respectively.

FIG. 2 shows the viscosity profile at 100 deg C. of the baseline fluid, and the baseline fluid containing 0.49 wt % NaCl, respectively.

### DETAILED DESCRIPTION OF SOME ILLUSTRATIVE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

Moreover, the description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

As used herein, the term “treatment”, or “treating”, refers to any subterranean operation that uses a fluid in conjunction with a desired function and/or for a desired purpose. The term “treatment”, or “treating”, does not imply any particular action by the fluid. The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

In some embodiments, the treatment fluid comprises a nonionic or non-hydrolyzed polyacrylamide and a delaying agent in a carrier fluid. The delaying agent will hydrolyze the nonionic or nonhydrolyzed polyacrylamide in the treatment fluid and therefore will increase the viscosity of the treatment fluid. The delaying agent may be water, or a base compound.

The carrier fluid may include any fluid understood in the art, aqueous or non-aqueous. The carrier fluid may be or may include an acid or an emulsified acid. Additionally, the carrier fluid may be brine, and/or may include brine. Also the carrier fluid may be a gas.

In one embodiment, the carrier fluid is foamed or energized fluid. The carrier fluid may contain “foamer”, most commonly surfactant or blends of surfactants that facilitate the dispersion of the gas into the first fluid in the form of small bubbles or droplets, and confer stability to the dispersion by retarding the coalescence or recombination of such bubbles or droplets. Foamed and energized fluids are generally described by their foam quality, i.e. the ratio of gas volume to the foam volume. If the foam quality is between 52% and 95%, the fluid is conventionally called foam, and below 52%, an energized fluid. However, as used herein the term “energized fluid” is defined as any stable mixture of gas and liquid, notwithstanding the foam quality value. The gas or the foam gas may be air, carbon dioxide, supercritical carbon dioxide, or nitrogen.

Crosslinking agents can also be added to the treatment fluid to generate crosslinked gelled fluids so as provide even higher viscosities, better proppant transport properties and to create fracture geometries not possible with other types of fluids. These cross-linked gelled fluids are highly viscous but non-Newtonian and shear thinning permitting them to be easy placed. While the viscous nature of the fluids is important for proppant transport, once the proppant is placed in the fracture it is not desirable for such fluids to remain in the proppant pack as the fluids can significantly hinder the flow of oil or gas in the propped fracture. In recognition of this, the treatment fluids may include “breakers” of various types that are designed to break the cross-linking bonds and reduce the molecular weight of the polymeric materials in such fracturing fluids after the proppant is placed thus dramatically reducing the viscosity of the fracturing fluid and allowing it to be easily flowed back to the surface from the proppant pack. Such chemical breakers can be added directly to the fluid. While the breakers are designed to break the crosslinking bonds and reduce the molecular weight of the polymeric materials in such fluids and significantly lower the viscosity of the fluids, it is important the breakers not reduce the fluid viscosity and transport capability prematurely while the fluid is being pumped. If a premature “break” of the fluid occurs during the fracturing operation, the loss of viscosity will dramatically limit the transport characteristics of the fracturing fluid. If this occurs while pumping, proppant can accumulate near the well bore rather than being carried into the created fracture. Such near well bore accumulation of proppant can lead to an early termination of a fracturing job due to excessive pumping pressure. This early termination is often referred to as a “screen out”. Conventional techniques for attempting to avoid an early breaking of the fluid viscosity have included limiting the amount of breaker added to the fracturing fluid and/or encapsulating the breaker with a material that will limit the contact of the breaker with the high molecular weight and/or cross-linked polymers in the fracturing fluid during pumping.

In some embodiments, the fluid uses viscoelastic surfactants (VES) as viscosifiers. The viscoelastic surfactant molecules, when present at a sufficient concentration, may aggregate into overlapping worm- or rod-like micelles, which confer the necessary viscosity to the fluid to carry the proppant during fracturing. At very high shear rate however, the viscosity may decrease. Also, the surfactant worm- or rod-like micelles tend to disaggregate by contact with hydrocarbons and, if no surfactant emulsion is effectively formed, the surfactant molecules are normally carried along the fracture, to the well bore, during the hydrocarbon backflow.

In some embodiments, the hydraulic fracturing is a water based treatment with friction reducers (referred as slickwater treatments), and pump the fracturing fluids at much higher rates in the formation. The proppant is carried to the formation due to the high flow rates. The limitation of the treatments is that the maximum proppant concentration that can be placed is limited to a small concentration since the fluid has low viscosity. Another limitation is very low fluid efficiency and therefore the size of the slickwater treatments.

In some embodiments, the delaying agent is water. In some embodiments, the delaying agent is a basic agent. The nature of the basic agent is not critical, but alkali metal basic compounds, for example ammonium, sodium or potassium hydroxides, carbonates, phosphates, alcoholates or silicates, are preferred. The concentration of alkali metal basic compound may vary for example within the range from 0.001 to 1 mole/liter, preferably from 0.05 to 0.5 mole/liter. Preferably, the higher concentrations will be used at low temperature and the lower concentrations at high temperature.

The treatment fluid may further comprise a viscosifying agent or thickener. In one embodiment, the viscosifying agent includes but is not limited to diutan gum, starches, welan gum, guar gum, xanthan gum, carboxymethylcellulose, alginate, methylcellulose, tragacanth gum and karaya gum.

According to some embodiments, the viscosifying agent may be a polysaccharide such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds.

According to some embodiments, the viscosifying agent may be a synthetic polymer such as polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

According to some embodiments, the viscosifying agent may be a cellulose derivative such as hydroxyethylcellulose (HEC) or hydroxypropylcellulose (HPC), carboxymethylhydroxyethylcellulose (CMHEC) and carboxymethycellulose (CMC). According to some embodiments, the viscosifying agent may be a biopolymer such as xanthan, diutan, and scleroglucan.

The treatment fluid may further comprise proppant materials. The selection of a proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated, provided that the resin and any other chemicals that might be released from the coating or come in contact with the other chemicals of the current application that are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L. The fluid may also contain other enhancers or additives.

Any additives normally used in treatment fluid can be included, again provided that they are compatible with the other components and the desired results of the treatment. Such additives can include, but are not limited to anti-oxidants, breakers, crosslinkers, corrosion inhibitors, delay agents, biocides, buffers, fluid loss additives, pH control agents, solid acids, solid acid precursors, etc. The wellbores treated can be vertical, deviated or horizontal. They can be completed with casing and perforations or open hole.

In one aspect, the treatment method is used for hydraulically fracturing a subterranean formation. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein, the disclosures of which are incorporated herein by reference thereto.

A spectrum of applications can be derived from the delayed viscosification of the treatment fluid containing nonionic PAM and base like NaOH. For example, adding nonionic PAM and NaOH to slickwater can re-boost the viscosity of the slickwater if it is reduced due to factors like high shear damage, decomposition, or formation absorption. As another example, adding nonionic PAM and NaOH to crosslinked fluids can re-boost the viscosity if the crosslinked fluids suffer viscosity drop at high temperatures.

The treatment fluid may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

To facilitate a better understanding, the following examples of embodiments are given. In no way should the following examples be read to limit, or define, the scope of the current application.

### EXAMPLES

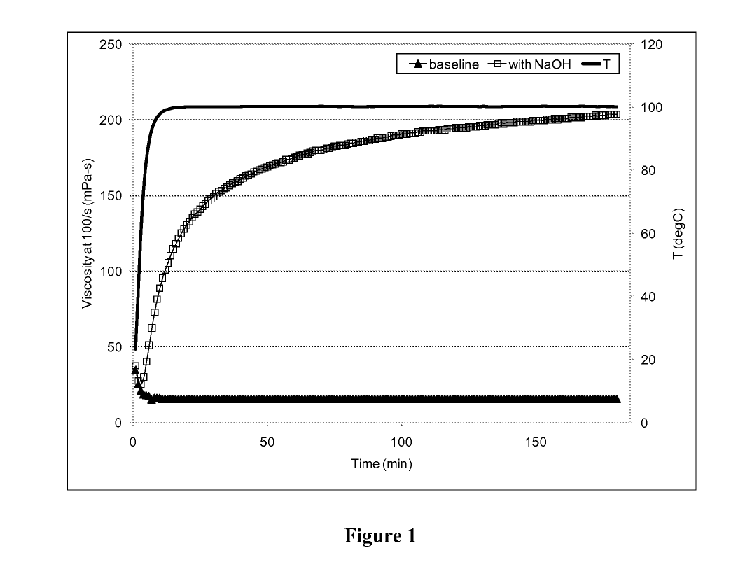

Nonionic or non-hydrolyzed polyacrylamide (PAM) particles dissolve very slowly in water at ambient temperature (about 65-75 deg F.). Upon dissolution, the nonionic PAM solution has a low viscosity. As shown in FIG. 1, the viscosity was about 15 cP (at 100/s shear) at 100 deg C. for a fluid (the baseline fluid) made up of 1 wt % nonionic PAM (Molecular weight: about 5-6 million) in de-ionized (DI) water.

Hydrolysis of polyacrylamide under basic conditions generates acrylate groups into the polymer, which can turn nonionic polyacrylamide into partially hydrolyzed polyacrylamide. The addition of about 0.34 wt % NaOH into the baseline fluid could induce the hydrolysis of a maximum of about 60% of the repeat units in the nonionic PAM. The viscosity (at 100/s shear) of the baseline fluid with 0.34 wt % NaOH at 100 deg C. was measured with a Fann50-type viscometer. As shown in FIG. 1, the fluid viscosity gradually went up, reaching above 200 cP at 3 hours. Partially hydrolyzed PAM usually shows higher viscosity than the corresponding nonionic PAM, as hydrolyzed PAM has a more extended conformation due to more charge repellence. FIG. 1 also shows that it took time for the hydrolysis reaction to progress between NaOH and nonionic PAM (i.e., there was a delay for the fluid to reach the final value of about 200 cP from the beginning much lower viscosity). If we had not dissolved the nonionic PAM particles in water in the beginning, we would have had more delay (for dissolving the nonionic PAM particles).

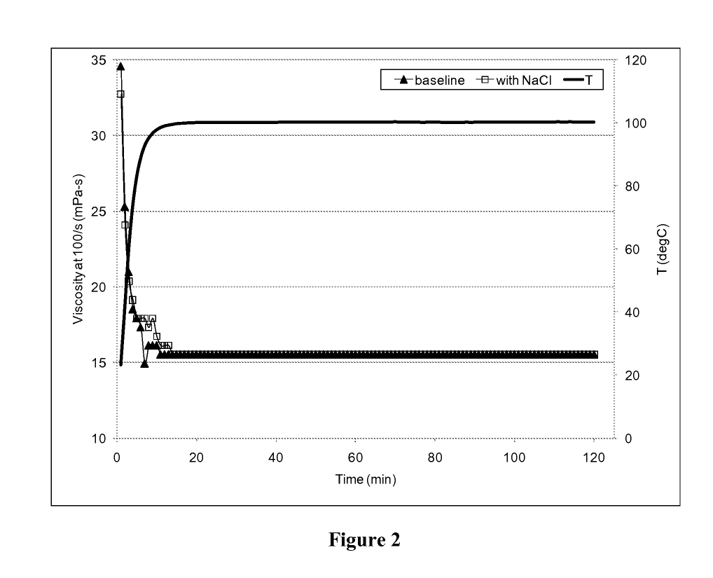

As the control test, when same molar concentration of some salts like NaCl (at about 0.49 wt %) is added to the baseline fluid, no delayed viscosification was observed in the fluid. The baseline had about the same viscosity at 100 deg C. as the baseline mixed with 0.49 wt % NaCl, as shown in FIG. 2.

While the disclosure has provided specific and detailed descriptions to various embodiments, the same is to be considered as illustrative and not restrictive in character. Only certain example embodiments have been shown and described. Those skilled in the art will appreciate that many modifications are possible in the example embodiments without materially departing from the disclosure. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

We claim:

1. A method of treating a portion of a subterranean formation comprising:
a. providing a treatment fluid comprising a carrier fluid, a non-hydrolyzed polyacrylamide or a non-hydrolyzed non ionic copolymer of acrylamide, and a delaying agent; and
b. treating the subterranean formation.

2. The method of claim 1, wherein the treatment fluid further comprises a viscosifying agent.

3. The method of claim 2, wherein the viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethycellulose (CMC), xanthan, diutan, scleroglucan and mixtures thereof.

4. The method of claim 2, wherein the viscosifying agent is viscoelastic surfactant.

5. The method of claim 1, wherein the delaying agent is water.

6. The method of claim 1, wherein the delaying agent is basic agent.

7. The method of claim 6, wherein the delaying agent is an alkali metal basic compound.

8. The method of claim 7, wherein the delaying agent is selected from the group consisting of ammonium hydroxides, sodium hydroxides, potassium hydroxides, carbonates, phosphates, alcoholates, silicates and mixtures thereof.

9. A method of fracturing a portion of a subterranean formation penetrated by a wellbore comprising:
a. providing a fracturing fluid comprising a carrier fluid and a non-hydrolyzed polyacrylamide or a non-hydrolyzed non ionic copolymer of acrylamide;
b. fracturing the portion of the subterranean formation with said fracturing fluid; and
c. providing to said fracturing fluid a delaying agent to increase the viscosity of the fracturing fluid.

10. The method of claim 9, wherein the fracturing fluid further comprises a viscosifying agent.

11. The method of claim 10, wherein the viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethycellulose (CMC), xanthan, diutan, scleroglucan and mixtures thereof.

12. The method of claim 10, wherein the viscosifying agent is viscoelastic surfactant.

13. The method of claim 9, wherein the delaying agent is water.

14. The method of claim 9, wherein the delaying agent is basic agent.

15. The method of claim 14, wherein the delaying agent is an alkali metal basic compound.

16. The method of claim 15, wherein the delaying agent is selected from the group consisting of ammonium hydroxides, sodium hydroxides, potassium hydroxides, carbonates, phosphates, alcoholates, silicates and mixtures thereof.

17. The method of claim 9, wherein the fracturing fluid further comprises proppant.

18. A method of fracturing a portion of a subterranean formation penetrated by a wellbore comprising:
a. providing a fracturing fluid comprising a carrier fluid, a viscosifying agent and a non-hydrolyzed polyacrylamide or a non-hydrolyzed non ionic copolymer of acrylamide;
b. fracturing the portion of the subterranean formation with said fracturing fluid; and
c. providing to said fracturing fluid a delaying agent to increase the viscosity of the fracturing fluid.

19. The method of claim 18, wherein the delaying agent is water.

20. The method of claim 18, wherein the delaying agent is basic agent.

21. The method of claim 20, wherein the delaying agent is an alkali metal basic compound.

22. The method of claim 21, wherein the delaying agent is selected from the group consisting of ammonium hydroxides, sodium hydroxides, potassium hydroxides, carbonates, phosphates, alcoholates, silicates and mixtures thereof.
